(19) United States
(12) Patent Application Publication
(10) Pub. No.: US 2025/0328461 A1
(43) Pub. Date: Oct. 23, 2025

(54) BLOCK ADDRESSING METHOD FOR MEMORY DEVICE AND MEMORY DEVICE

(71) Applicant: Winbond Electronics Corp., Taichung City (TW)

(72) Inventors: Yi-Chen Fan, Hsinchu County (TW); Katsutoshi Suito, Tokyo (JP)

(73) Assignee: Winbond Electronics Corp., Taichung City (TW)

(21) Appl. No.: 18/789,594

(22) Filed: Jul. 30, 2024

(30) Foreign Application Priority Data
Apr. 18, 2024 (TW) 113114491

(51) Int. Cl. G06F 12/02

(52) U.S. Cl. CPC G06F 12/0246; G06F 2212/7201

(57) ABSTRACT

A block addressing method for a memory device and a memory device are provided. The block addressing method includes: dividing a memory array in the memory device into N partitions, where N is an integer; converting a physical address of each of a plurality of blocks of the memory device into a logical address according to a specific mapping rule; and addressing the blocks to the N partitions according to the logical addresses.

### CROSS-REFERENCE TO RELATED APPLICATION

This application claims the priority benefit of Taiwan application serial no. 113114491, filed on Apr. 18, 2024. The entirety of the above-mentioned patent application is hereby incorporated by reference herein and made a part of this specification.

### BACKGROUND

### Technical Field

The disclosure relates to a block addressing method for a memory device and a memory device.

### Description of Related Art

Regarding NAND flash memory, due to process factors, there are usually some initial bad blocks. The specification sheet stipulates that the size of bad blocks before shipping shall be less than 2% of the chip size.

The initial bad blocks are usually in critical regions, which results in insufficient partition memory to store data. As a result, users cannot use the chip most of the time. The reason is that this type of flash memory usually does not have a controller, and users cannot use the controller to manage the array blocks of NAND flash memory. Therefore, the distribution of bad blocks may limit the use of this type of memory.

Therefore, how to solve the problem of initial bad blocks so that users can still use this memory even if there are initial bad blocks in the memory, is a problem to be solved.

### SUMMARY

Based on the above description, according to an embodiment of the disclosure, the disclosure provides a block addressing method for a memory device. The block addressing method includes the following steps. A memory array of the memory device is divided into N partitions, where N is an integer. A physical address of each of a plurality of blocks of the memory device is converted into a logical address according to a specific mapping rule. According to the logical addresses, the blocks are addressed to the N partitions.

According to the above implementation, in the block addressing method, the specific mapping rule is to convert the blocks of the logical addresses to the N partitions through the following manner. That is, Partition 1: Blocks 0, N, 2N, 3N, . . . , Partition 2: Blocks 1, N+1, 2N+1, 3N+1, . . . , Partition 3: Blocks 2, N+2, 2N+2, 3N+2, . . . , . . . , and Partition N: Blocks N−1, 2N−1, 3N−1, . . . .

According to the above implementation, in the block addressing method, the memory device is a NAND flash memory device.

According to another embodiment, the disclosure further provides a memory device including a memory array and a decoder. The memory array is divided into N partitions, where N is an integer. The decoder is coupled to the memory array, converts a physical address of each of a plurality of blocks of the memory into a logical address according to a specific mapping rule, and addresses the blocks to the N partitions according to the logical addresses.

According to another embodiment, the disclosure further provides block addressing method for a memory device. The block addressing method includes the following steps. A memory array of the memory device is divided into N partitions, where N is an integer. N blocks among a plurality of blocks of the memory device are treated as a unit, and the N blocks are addressed into partitions P1 to PN one by one until all the blocks are addressed.

To sum up, according to the embodiments of the disclosure, each block is re-addressed by dividing the memory array into multiple parts. In this way, even if the memory has dense initial bad blocks, a user is still able to use this memory, so that the problem of being unable to use the memory chip is solved.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a conventional block addressing method.

FIG. 2 is a schematic diagram of a block addressing method according to an embodiment of the disclosure.

FIG. 3 is an architectural schematic diagram of a memory device according to an embodiment of the disclosure.

### DESCRIPTION OF THE EMBODIMENTS

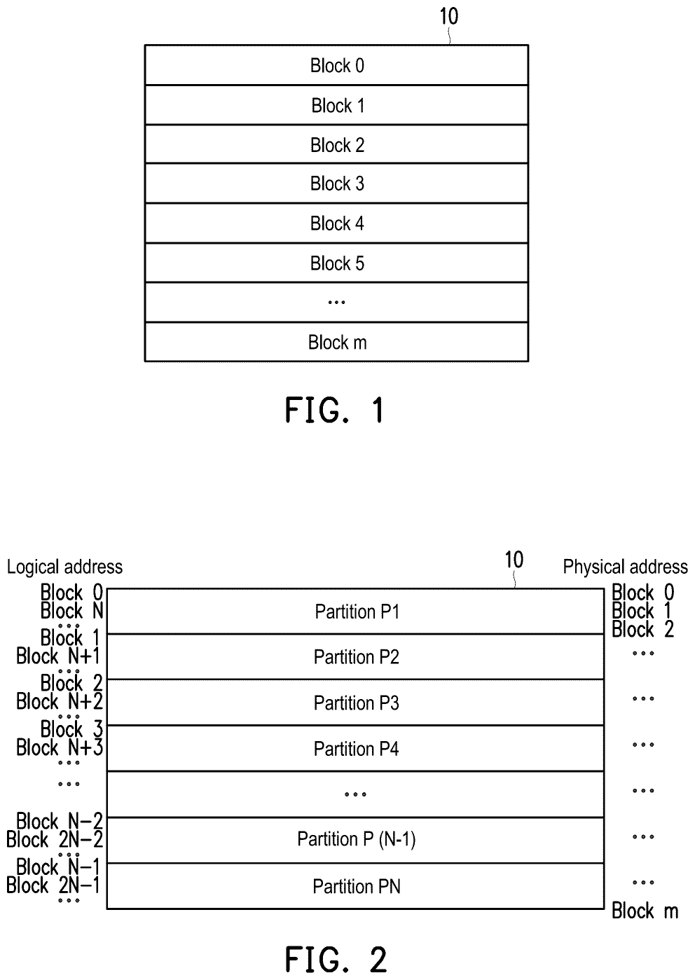

As shown in FIG. 1, a current block addressing method for a memory is to arrange m blocks Block0 to Block m in sequence in a memory array. As a comparative example, it is assumed that initial bad blocks are located in Block 1, Block 4, and Block 5. If a user needs 16 blocks to store codes in a first partition (initial partition) and can tolerate 2 bad blocks, then the user needs to use Blocks 0 to 17 as the first partition.

In this case, this partition has a total of 18 blocks, but there are 3 bad blocks, namely Block 1, Block 4, and Block 5 as mentioned above. Therefore, among the 18 blocks Blocks 0 to 17, only 15 blocks are left as valid blocks. Therefore, there are not enough blocks left to store the code. It thus can be seen that if the bad blocks are excessively dense, the user is unable to use a memory chip.

Therefore, the embodiments of the disclosure provide a block addressing method. As shown in FIG. 2, a memory array 10 is divided into N partitions P1 to PN first, where N is an integer. Herein, the integer N can be set according to actual usage needs. In addition, the right side of the partitions P1 to PN shown in FIG. 2 indicates physical addresses of a plurality of blocks, and the left side indicates logical addresses of the blocks.

Next, after a memory device is manufactured, the blocks of the memory are continuously arranged in the memory array 10 with their actual locations most of the time, that is, they are addressed by their physical addresses. However, according to the embodiments of the disclosure, the physical addresses of the blocks are converted into the logical addresses through a specific mapping rule. The blocks are then addressed to the N partitions P1 to PN according to the logical addresses.

According to the embodiments of the disclosure, when the blocks are being addressed, N blocks are treated as a unit, and the N blocks are allocated to the partitions P1 to PN one by one. In addition, the partitions P1 to PN may be configured with j blocks (j is an integer), so the total number of blocks is m=j×N. After every N blocks are addressed, the following N blocks are then addressed until all blocks are addressed. For instance, initially the first group of N blocks Block 0 to Block N−1 are sequentially addressed to the partitions P1 to PN. In the same manner, the second group of N blocks Block N to Block 2N−1 are then sequentially addressed to the partitions P1 to PN. Proceed in the same manner until all blocks are addressed. As an example, this specific mapping rule may be the following manner:
Partition 1: Blocks 0, N, 2N, 3N, . . .
Partition 2: Blocks 1, N+1, 2N+1, 3N+1, . . .
Partition 3: Blocks 2, N+2, 2N+2, 3N+2, . . .
. . . , and
Partition N: Blocks N−1, 2N−1, 3N−1 . . . .

In other words, in this way, the addressing mode of each block is converted from a physical address to a logical address. Therefore, when writing data to the memory array is performed, the data is written based on the logical addresses. Herein, from the perspective of physical addresses, bad blocks that are originally relatively concentrated are dispersed. After conversion to logical addresses, the bad blocks may not be excessively concentrated.

As a specific example, same as the above comparative example, it is assumed that there are 3 bad blocks in the initial block, such as Block 1, Block 4, and Block 5 (physical addresses). Next, the memory array 10 is divided into 16 partitions P1 to P16, that is, N=16. In this way, the physical addresses 1, 4, and 5 of Block 1, Block 4, and Block 5 can be converted to logical locations 16, 64, and 80, that is, the logical addresses of Block 16, Block 64, and Block 80.

Therefore, under the same conditions, the user needs 16 blocks to store codes and can tolerate 2 bad blocks. In this case, the user needs to use blocks Block 0 to 17 of the logical address as the first partition. In this way, the first partition has 18 blocks, and only Block 16 is a bad block in the first partition, but the original physical addresses of Block 4 and Block 5 are converted to logical addresses of Block 64 and Block 80.

Therefore, after re-addressing the blocks, there is only one bad block left in the first partition. Therefore, after a total of 18 blocks minus 1 initial bad block (Block 16), there are still 17 valid blocks. Therefore, the number of blocks is sufficient for storing codes. Therefore, in this way, when data is written into each block, the number of bad blocks in the first partition can be reduced because the logical addresses of the bad blocks are dispersed. Therefore, even if there are many and dense initial bad blocks in the memory array 10, the originally densely distributed initial bad blocks can be dispersed through the logical address addressing method provided by the disclosure, so that the memory chip still meets the user's usage specifications.

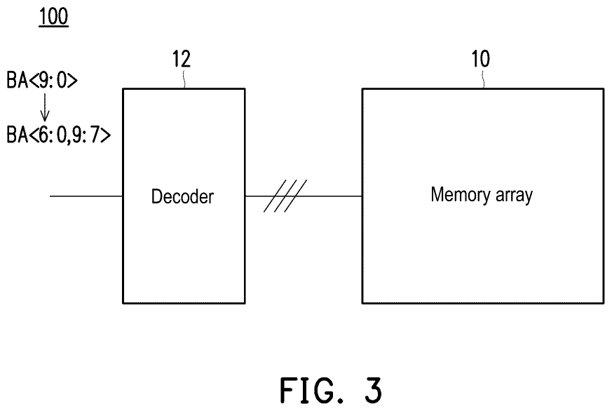

As shown in FIG. 3, which illustrates an architectural schematic diagram of a memory device according to the disclosure. The memory device at least includes the memory array 10 and a decoder 12. This decoder 12 is, for example, a row decoder (X-DEC). As an example, the memory array 10 is divided into 8 partitions P1 to P8 according to the previous manner, and each of the partitions P1 to P8 can have 128 blocks. In this way, through the mapping rule as described above, the original block address BA<9:0> is as shown in Table One, and the new block location BA<6:0,9:7> is shifted by 3 bits.

In this example, when the physical address of Block 0 is addressed to the logical address of Block 0. Next, when the physical address of the block is increased by 1, that is, the physical address of Block 1 is addressed to the logical address of Block 128. After that, all blocks (i.e., 128×8=1024, i.e., 1G size) are addressed in this way.

TABLE One

| Decoding Form | BA | | | | | | | | | |
|---|---|---|---|---|---|---|---|---|---|---|
| Related Art | 9 | 8 | 7 | 6 | 5 | 4 | 3 | 2 | 1 | 0 |
| This Embodiment | 6 | 5 | 4 | 3 | 2 | 1 | 0 | 9 | 8 | 7 |

In view of the foregoing, according to the embodiments of the disclosure, each block is re-addressed by dividing the memory array into multiple parts. In this way, even if the memory has initial bad blocks, the user is still able to use this memory, so that the problem of being unable to use the memory chip is solved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A block addressing method for a memory device, comprising:
dividing a memory array of the memory device into N partitions, wherein N is an integer;
converting a physical address of each of a plurality of blocks of the memory device into a logical address according to a specific mapping rule; and
addressing the blocks to the N partitions according to the logical addresses.

2. The block addressing method for the memory device according to claim 1, wherein the specific mapping rule is to convert the blocks of the logical addresses to the N partitions through the following manner,
Partition 1: Blocks 0, N, 2N, 3N, . . .
Partition 2: Blocks 1, N+1, 2N+1, 3N+1, . . .
Partition 3: Blocks 2, N+2, 2N+2, 3N+2, . . .
. . . , and
Partition N: Blocks N−1, 2N−1, 3N−1 . . . .

3. The block addressing method for the memory device according to claim 1, wherein the memory device is a NAND flash memory device.

4. A memory device, comprising:
a memory array divided into N partitions, wherein N is an integer; and
a decoder coupled to the memory array, converting a physical address of each of a plurality of blocks of the memory into a logical address according to a specific mapping rule, and addressing the blocks to the N partitions according to the logical addresses.

5. The memory device according to claim 4, wherein the specific mapping rule is to convert the blocks of the logical addresses to the N partitions through the following manner:
Partition 1: Blocks 0, N, 2N, 3N, . . .
Partition 2: Blocks 1, N+1, 2N+1, 3N+1, . . .
Partition 3: Blocks 2, N+2, 2N+2, 3N+2, . . .
. . . , and
Partition N: Blocks N−1, 2N−1, 3N−1 . . . .

6. The memory device according to claim 4, wherein the decoder is a row decoder.

7. The memory device according to claim 4, wherein the memory device is a NAND flash memory device.

8. A block addressing method for a memory device, comprising:
dividing a memory array of the memory device into N partitions, wherein N is an integer; and
treating N blocks among a plurality of blocks of the memory device as a unit and addressing the N blocks into partitions P1 to PN one by one until all the blocks are addressed.

9. The block addressing method for the memory device according to claim 8, wherein the rule for addressing the blocks to the N partitions is:
Partition 1: Blocks 0, N, 2N, 3N, . . .
Partition 2: Blocks 1, N+1, 2N+1, 3N+1, . . .
Partition 3: Blocks 2, N+2, 2N+2, 3N+2, . . .
. . . , and
Partition N: Blocks N−1, 2N−1, 3N−1 . . . .

10. The block addressing method for the memory device according to claim 8, wherein the memory device is a NAND flash memory device.
